(19) United States
(12) Patent Application Publication
(10) Pub. No.: US 2008/0182690 A1
(43) Pub. Date: Jul. 31, 2008

(54) Undeformable Transmission Mechanism

(76) Inventor: Cheng-Feng Lin, Taichung (TW)

Correspondence Address: Dr. BANGER SHIA, 102 Lindencrest Ct., Sugar Land, TX, 77479-5201, US

(21) Appl. No.: 11/627,943

(22) Filed: Jan. 26, 2007

(51) Int. Cl. F16H 7/20

(52) U.S. Cl. 474/198

(57) ABSTRACT

An undeformable transmission mechanism comprises a table, a transmission member, a rotating shaft and a supporting member. The rotating shaft, the transmission member and the supporting member are assembled on the table, and the supporting member is disposed at one end of the rotating shaft. When the transmission member rotates the rotating shaft, the rotating shaft will produce a deviation force, and the supporting member is provided for reducing the deviation force, so as to prolong the life of the rotating shaft and to reduce the cost of maintaining and replacing the rotating shaft.

### BACKGROUND OF THE INVENTION

1. Field of the Invention

The present invention relates to a transmission mechanism, and more particularly to an undeformable transmission mechanism.

2. Description of the Prior Art

As far as a conventional transmission mechanism is concerned, the transmission method is usually to use a transmission member to rotate a rotating shaft, and then the rotating shaft's rotation is used to drive other mechanisms, which comprises the following driving methods: belt driving, gear driving and worm driving. The method of belt driving is shown in FIG. 1, a transmission member B and a rotating shaft C are assembled on a table A, a belt D is driven by a driving wheel B1 to rotate a follower wheel C1 of the rotating shaft C, and the follower wheel C1 is fixed to the rotating shaft C.

However, when the transmission member B rotates the rotating shaft C, the belt D must be tensioned between the driving wheel B1 and the follower wheel C1 in such a manner that the belt D will pull the follower wheel C1 to cause a deviation force F towards the driving wheel B1. And after a long period of use, the rotating shaft C will be deformed by the influence of the deviation force F, and even fractured after a certain part is damaged completely. Thereby, the manufacture process will be influenced, and the rotating shaft C must be maintained frequently to avoid the occurrence of fracture. If the hardness of the rotating shaft C is low or the outer diameter of the rotating shaft C is small, the rotating shaft C must be maintained almost every day, and must be replaced almost every one to two months, such that the cost is increased. In addition to the belt driving, so long as the rotating shaft is driven by the transmission member directly, the deviation force will be produced, and the rotating shaft is likely to be deformed or fractured. Therefore, how to research a transmission mechanism that can prolong the life of the rotating shaft has become an important issue for the manufacturers.

The present invention has arisen to mitigate and/or obviate the afore-described disadvantages.

### SUMMARY OF THE INVENTION

The primary objective of the present invention is to provide an undeformable transmission mechanism comprises a supporting member fixed to a table for reducing a deviation force of a rotating shaft.

The undeformable transmission mechanism comprises a transmission member, a rotating shaft and a supporting member. The rotating shaft is rotatably assembled on the table and is rotated by the transmission member assembled on the table. The supporting member is fixed to the table and is disposed at one end of the rotating shaft correspondingly to the transmission member, and the supporting member is abutted against the side of the rotating shaft facing in the direction of the deviation force in such a manner that the deviation force F can be reduced, so as to prolong the life of the rotating shaft and to reduce the cost of maintaining and replacing the rotating shaft. In addition, the supporting member of the present invention can be a bearing or a protruded block for reducing the deviation force of the rotating shaft, and the supporting member also can be fixed to the table directly or by a positioning seat.

The present invention will become more obvious from the following description when taken in connection with the accompanying drawings, which show, for purpose of illustrations only, the preferred embodiments in accordance with the present invention.

### BRIEF DESCRIPTION OF THE DRAWINGS

FIG. 1 is an illustrative view of a conventional transmission mechanism;

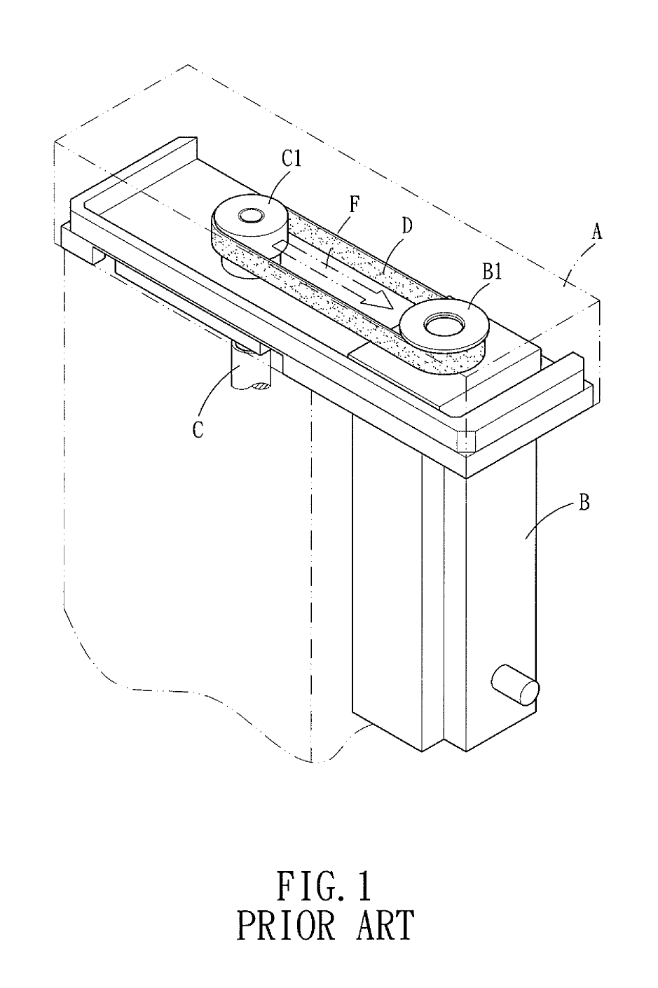

FIG. 2 is an illustrative view of a supporting member in accordance with an undeformable transmission mechanism of the present invention, wherein the supporting member is a bearing;

FIG. 3 is an illustrative view of the supporting member in accordance with the undeformable transmission mechanism of the present invention, wherein the supporting member is a protruded block directly fixed to a table;

FIG. 4 is an illustrative view of the supporting member in accordance with the undeformable transmission mechanism of the present invention; wherein the supporting member is a protruded block fixed to the table by a positioning seat;

FIG. 5 is an illustrative view of the supporting member in accordance with the undeformable transmission mechanism of the present invention; wherein the supporting member is made of two protruded blocks directly fixed to the table; and

FIG. 6 is an illustrative view of the supporting member in accordance with the undeformable transmission mechanism of the present invention; wherein the supporting member is made of two protruded blocks fixed to the table by the positioning seat.

### DETAILED DESCRIPTION OF THE PREFERRED EMBODIMENTS

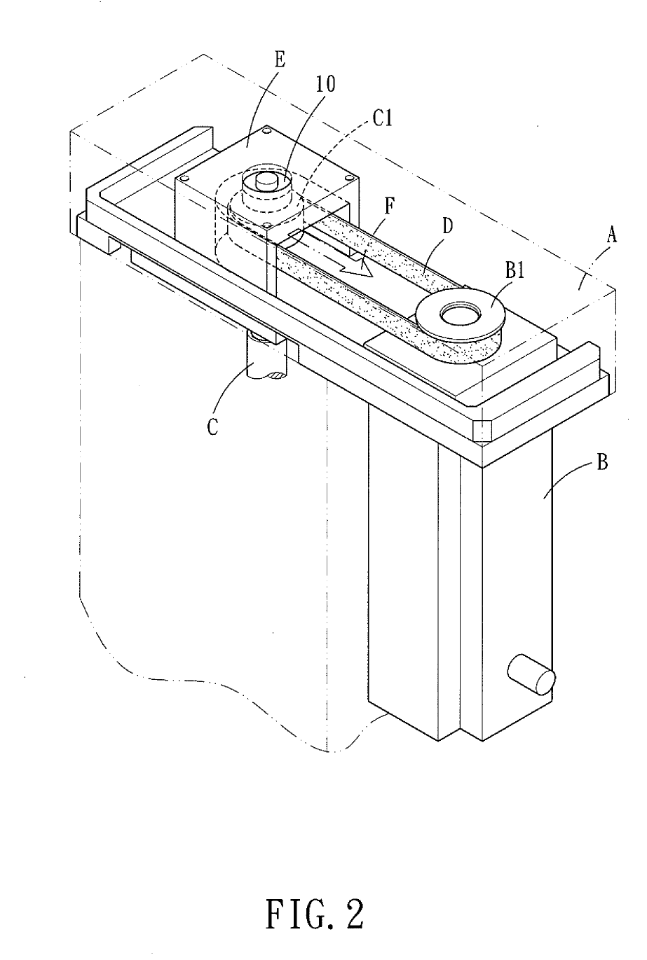

Referring to FIG. 2, an undeformable transmission mechanism in accordance with the present invention comprises: a table A, a transmission member B, a rotating shaft C, a belt D, and a supporting member 10.

The transmission member B is assembled on the table A and is fixed with a driving wheel B1.

The rotating shaft C is rotatably assembled on the table A and is fixed with a follower wheel C1.

The belt D is tensioned between the driving wheel B1 and the follower wheel C1, the belt D is driven by the driving wheel B1 to rotate the follower wheel C1, and then the follower wheel C1 rotates the rotating shaft C. In addition, since the belt D is tensioned between the driving wheel B1 and the follower wheel C1, the belt D will pull the follower wheel C1 to cause a deviation force F towards the driving wheel B1.

The supporting member 10 is fixed to the table A and is disposed at one end of the rotating shaft C correspondingly to the transmission member B, and the supporting member 10 has an arc-shaped surface (not shown) that is abutted against the side of the rotating shaft C facing in the direction of the deviation force F. In this embodiment, the supporting member 10 is disposed at the end of the rotating shaft C when the follower wheel C1 is located, and the supporting member 10 is a bearing which is fixed to the table A and is mounted on the rotating shaft C by a positioning seat E.

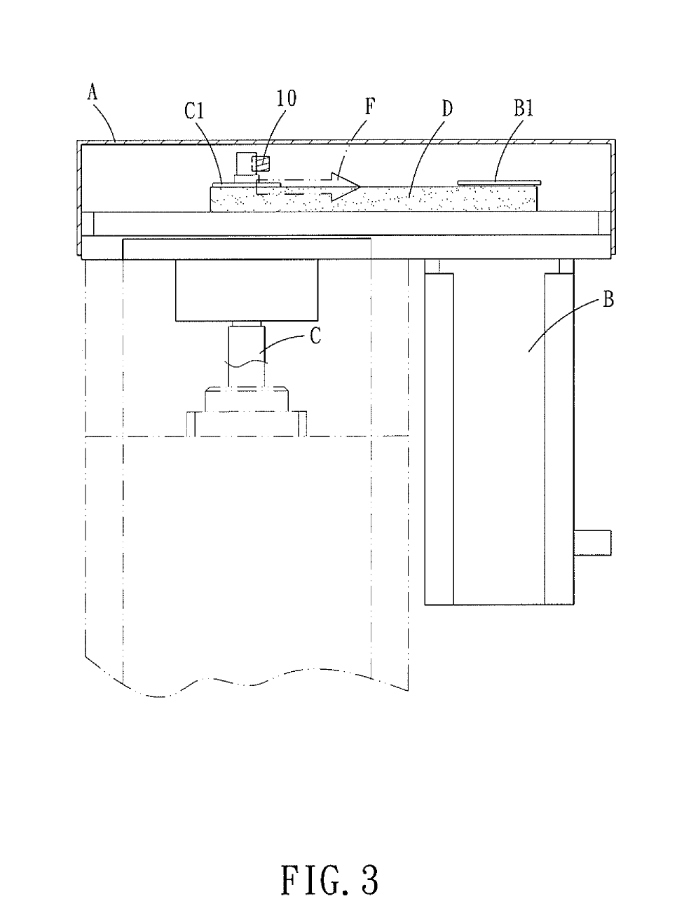

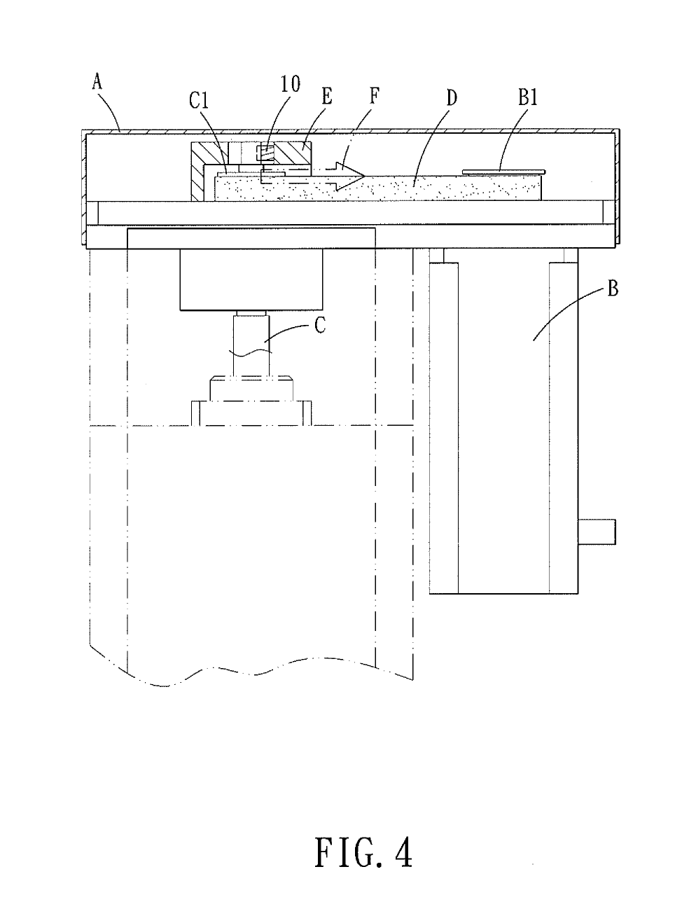

In addition, the supporting member 10 of the present invention can be a protruded copper block directly fixed to the table A as shown in FIG. 3, or a protruded copper block fixed to the table A by the positioning seat E as shown in FIG. 4.

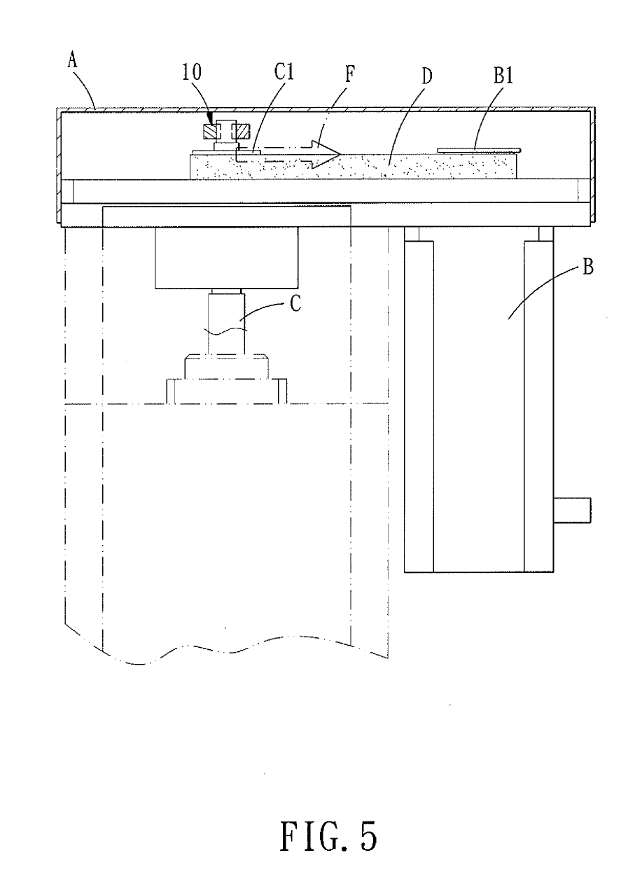

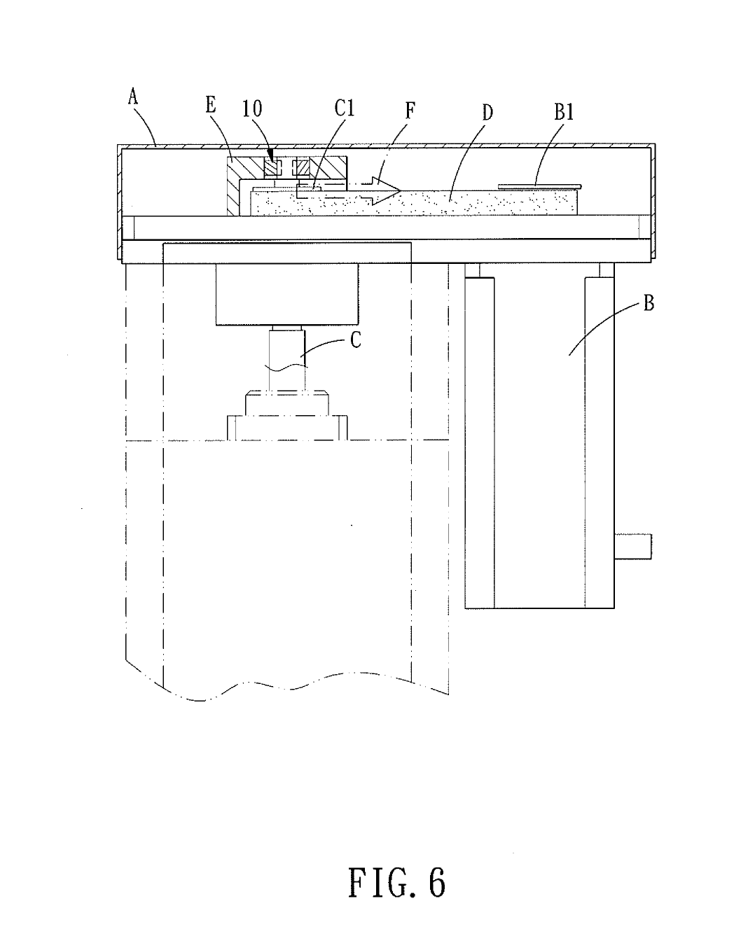

Further, with reference to FIG. 5, the supporting member 10 can be made of two protruded copper blocks located opposite to each other and directly fixed to the table A, the arc-shaped surface of one of the protruded blocks is abutted against the side of the rotating shaft C facing in the direction of the deviation force F, and the abutting surface of the other protruded block and the rotating shaft C is the arc-shaped surface. Or the supporting member 10 also can be made of two protruded copper blocks located opposite to each other and fixed to the table A by the positioning seat E as shown in FIG. 6, the arc-shaped surface of one of the protruded blocks is abutted against the side of the rotating shaft C facing in the direction of the deviation force F, and the abutting surface of the other protruded block and the rotating shaft C is the arc-shaped surface.

As can be clearly seen from the above-mentioned structure, since the supporting member 10 is abutted against the side of the rotating shaft C facing in the direction of the deviation force F, the supporting member 10 is located at the driving direction of the deviation force F in such a manner that the deviation force F can be reduced. Thereby, the rotating shaft C will unlikely to be deformed under the condition that the deviation force F is reduced, so as to prolong the life of the rotating shaft C and to reduce the maintenance cost. Moreover, the rotating shaft C is unlikely to be deformed, in other words, the rotating shaft C is unlikely to be fractured, so as to reduce the cost of replacing the rotating shaft C.

The present invention is characterized in that: the supporting member 10 is provided for reducing the deviation force F of the rotating shaft C, the above-mentioned bearing and protruded blocks are only the preferred embodiments, and the methods of fixing the supporting member 10 to the table A directly or by the positioning seat E are the description of the embodiments of the present invention.

To summarize, an undeformable transmission mechanism comprises a table, a transmission member, a rotating shaft and a supporting member. The rotating shaft, the transmission member and the supporting member are assembled on the table, and the supporting member is disposed at one end of the rotating shaft. When the transmission member rotates the rotating shaft, the rotating shaft will produce a deviation force, and the supporting member is provided for reducing the deviation force, so as to prolong the life of the rotating shaft and to reduce the cost of maintaining and replacing the rotating shaft.

While we have shown and described various embodiments in accordance with the present invention, it should be clear to those skilled in the art that further embodiments may be made without departing from the scope of the present invention.

What is claimed is:

1. An undeformable transmission mechanism, comprising: a table, a transmission member and a rotating shaft, the rotating shaft being rotatably assembled on the table and rotated by the transmission member, characterized in that:
a supporting member is fixed to the table and is disposed at one end of the rotating shaft correspondingly to the transmission member, and the supporting member is abutted against a side of the rotating shaft facing in a direction of a deviation force.

2. The undeformable transmission mechanism as claimed in claim 1, wherein an abutting surface of the supporting member and the rotating shaft is an arc-shaped surface.

3. The undeformable transmission mechanism as claimed in claim 2, wherein the supporting member is a bearing which is fixed to the table and is mounted on the rotating shaft by a positioning seat.

4. The undeformable transmission mechanism as claimed in claim 2, wherein the supporting member is a protruded block fixed to the table directly.

5. The undeformable transmission mechanism as claimed in claim 2, wherein the supporting member is a protruded block fixed to the table by a positioning seat.

6. The undeformable transmission mechanism as claimed in claim 2, wherein the supporting member is made of two protruded blocks located opposite to each other and directly fixed to the table, the arc-shaped surface of one of the protruded blocks is abutted against the side of the rotating shaft facing in the direction of the deviation force, and the abutting surface of the other protruded block and the rotating shaft is the arc-shaped surface.

7. The undeformable transmission mechanism as claimed in claim 2, wherein the supporting member is made of two protruded blocks located opposite to each other and fixed to the table by a positioning seat, the arc-shaped surface of one of the protruded blocks is abutted against the side of the rotating shaft facing in the direction of the deviation force, and the abutting surface of the other protruded block and the rotating shaft is the arc-shaped surface.
